(19) United States
(12) Patent Application Publication
(10) Pub. No.: US 2015/0268365 A1
(43) Pub. Date: Sep. 24, 2015

(54) METHOD TO CHARACTERIZE GEOLOGICAL FORMATIONS USING SECONDARY SOURCE SEISMIC DATA

(71) Applicant: Schlumberger Technology Corporation, Sugar Land, TX (US)

(72) Inventors: HUGUES A. DJIKPESSE, CAMBRIDGE, MA (US); RICHARD PARKER, CALGARY (CA)

(73) Assignee: Schlumberger Technology Corporation, Sugar Land, TX (US)

(21) Appl. No.: 14/218,446

(22) Filed: Mar. 18, 2014

(51) Int. Cl. G01V 1/30; G01V 1/40

(52) U.S. Cl. CPC G01V 1/306; G01V 1/40

(57) ABSTRACT

A method for determining an elastic property of a geological formation, such as Thomsen parameter delta, is described herein. The method includes identifying a secondary Sv-wave and its associated arrival time within seismic data obtained from an array of seismic receivers. An elastic property of the geological formation is determined using the associated arrival time of the secondary Sv-wave.

### TECHNICAL FIELD

This disclosure relates to characterization of geological formations, and more particularly to the characterization of elastic properties of geological formations.

### BACKGROUND

Anisotropy refers to a medium with properties that depend on a direction of measurement. In one example, the speed of seismic waves that travel through an elastically anisotropic medium will vary depending on wave propagation direction and polarization direction (e.g., direction of particle displacement by a propagating elastic wave). The presence of elastic anisotropy can have significant and relevant implications. For instance, subsurface stresses in elastically anisotropic media can be very different (e.g., both in magnitude and direction) from those existing in elastically isotropic media.

Geological formations, such as unconventional shale reservoirs, are anisotropic. In particular, unconventional shale reservoirs are transversely isotropic (TI). Subsurface stress magnitude and orientation are useful in analyzing and understanding the behavior of such geological formations. For example, microseismic studies can be used to monitor a fracturing operation of an unconventional shale reservoir. The microseismic studies can identify and predict the formation of fractures within the reservoir during the fracturing operation. If unaccounted for during the study, the presence of elastic anisotropy in geological formations can lead to errors in analysis of the formation, such as errors in time-to-depth conversion, normal moveout (NMO) correction, dip moveout (DMO) correction, migration, and amplitude versus offset (AVO) analysis.

Transversely isotropic formations, such as unconventional shale reservoirs, can be characterized using mass density (ρ_{b}) and five elastic parameters. The five elastic parameters include: (i) vertical velocity of a compressional primary waves (P-waves) (α), (ii) vertical velocity of shear waves (S-waves) (β), and (iii) Thomsen parameter epsilon (ε), (iv) Thomsen parameter gamma (γ), and (v) Thomsen parameter delta (δ).

### SUMMARY

Illustrative embodiments of the present disclosure are directed to a method for determining an elastic property of a geological formation, such as Thomsen parameter delta. The method includes identifying a secondary Sv-wave and its associated arrival time within seismic data obtained from an array of seismic receivers. An elastic property of the geological formation is determined using the associated arrival time of the secondary Sv-wave.

In a more specific embodiment, the method further includes performing a perforation operation in a treatment well and receiving seismic data generated by the perforation operation at the array of seismic receivers located within a monitoring well. The perforation operation produces a wave that is converted to a secondary Sv-wave that travels through the geological formation to the array of receivers located in the monitoring well. The secondary Sv-wave is used to determine an elastic property of the geological formation.

Various embodiments of the present disclosure are also directed a system for determining an elastic property of a geological formation, such as Thomsen parameter delta. The system includes a processing system configured to (i) identify a secondary Sv-wave and its associated arrival time within seismic data obtained from an array of seismic receivers and (ii) determine the elastic property of the geological formation using the associated arrival time of the secondary Sv-wave.

The system may also include (i) an array of seismic receivers deployed within a first wellbore and configured to receive seismic waves and (ii) a seismic source deployed within a second wellbore and configured to generate seismic waves that travel to the first wellbore.

Illustrative embodiments of the present disclosure are also directed to a non-transitory computer readable medium encoded with instructions, which, when loaded on a computer, establish processes for determining an elastic property of a geological formation. The processes include identifying a secondary Sv-wave and its associated arrival time within seismic data obtained from an array of seismic receivers and determining the elastic property of the geological formation using the associated arrival time of the secondary Sv-wave.

### BRIEF DESCRIPTION OF THE DRAWINGS

Those skilled in the art should more fully appreciate advantages of various embodiments of the present disclosure from the following “Description of Illustrative Embodiments, discussed with reference to the drawings summarized immediately below.

FIG. 1A-E show sensitivities of group velocities of seismic waves, as a function of phase angle measured from a vertical symmetry axis, when varying one Thomsen parameter and keeping the two other parameters equal to zero.

FIG. 2 shows two well sites and a system for determining an elastic property of a geological formation in accordance with one embodiment of the present disclosure;

FIG. 3 shows a method for determining an elastic property of a geological formation in accordance with one embodiment of the present disclosure;

FIG. 4 shows a geographic arrangement for a vertical monitoring well and a vertical treatment well used to collect seismic data in accordance with one embodiment of the present disclosure;

FIGS. 5A and 5B show seismic data for a perforation shot (FIG. 5A) and a microseismic event (FIG. 5B) that occurred as a result of the perforation shot in accordance with one embodiment of the present disclosure;

FIG. 6A shows waveforms from a radial component of FIG. 5A in accordance with one embodiment of the present disclosure;

FIG. 6B shows waveforms from a vertical component of FIG. 5A in accordance with one embodiment of the present disclosure;

FIG. 7 shows a two-dimensional marginal probability density for Thomsen parameters epsilon and delta that was generated by performing an inversion using direct P-wave arrival times;

FIG. 8 shows a joint probability density for Thomsen parameters epsilon and delta that was generated by performing an inversion using secondary Sv-wave arrival times in accordance with one embodiment of the present disclosure;

FIG. 9 shows a joint probability density for Thomsen parameters epsilon and delta that was generated by performing an inversion using both direct P-wave arrival times and secondary Sv-wave arrival times in accordance with one embodiment of the present disclosure;

FIG. 10A shows a one-dimensional marginal probability density for parameter epsilon in accordance with one embodiment of the present disclosure;

FIG. 10B shows a one-dimensional marginal probability density for parameter delta in accordance with one embodiment of the present disclosure;

FIG. 11A shows a joint probability density function for Thomsen parameters epsilon and delta that was generated by performing an inversion using secondary Sv-wave arrival times in accordance with one embodiment of the present disclosure; and

FIG. 11B shows a joint probability density function for Thomsen parameters epsilon and delta that was generated by performing an inversion using both direct P-wave arrival times and secondary Sv-wave arrival times in accordance with one embodiment of the present disclosure.

### DESCRIPTION OF ILLUSTRATIVE EMBODIMENTS

Illustrative embodiments of the disclosure are directed to a method, a system, and a computer readable medium that determine an elastic property of a geological formation. Sv-wave velocities are used to determine Thomsen parameter delta. However, perforation shots and various other seismic sources do not always produce substantial Sv-waves. For this reason, Thomsen parameter delta can be difficult to determine from seismic data obtained from such sources. The method described herein uses a secondary Sv-wave and its associated arrival time at an array of detectors to determine Thomsen parameter delta. In this manner, the method facilitates determination of each elastic parameter of the geological formation using perforation shots and other seismic sources that do not produce substantial Sv-waves. Details of various embodiments are discussed below.

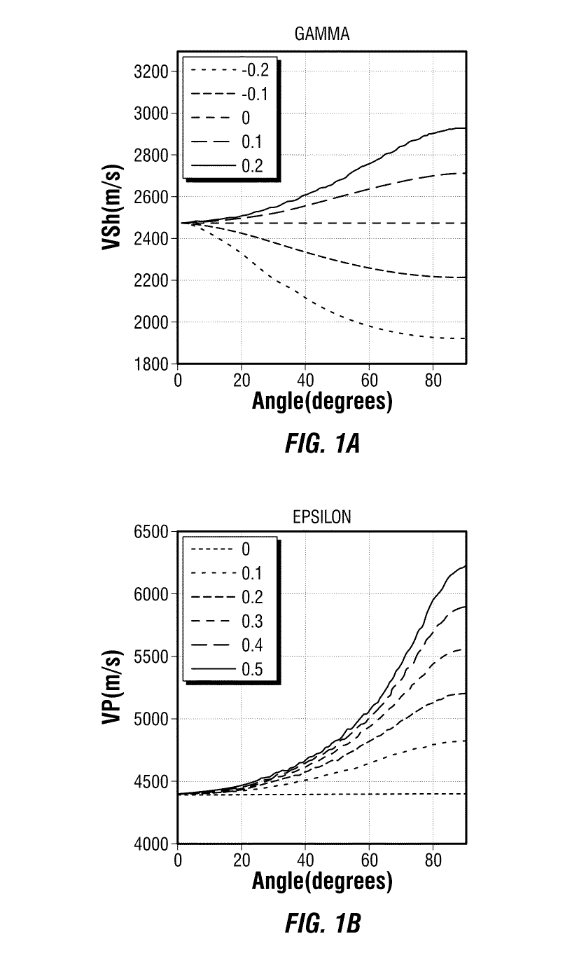

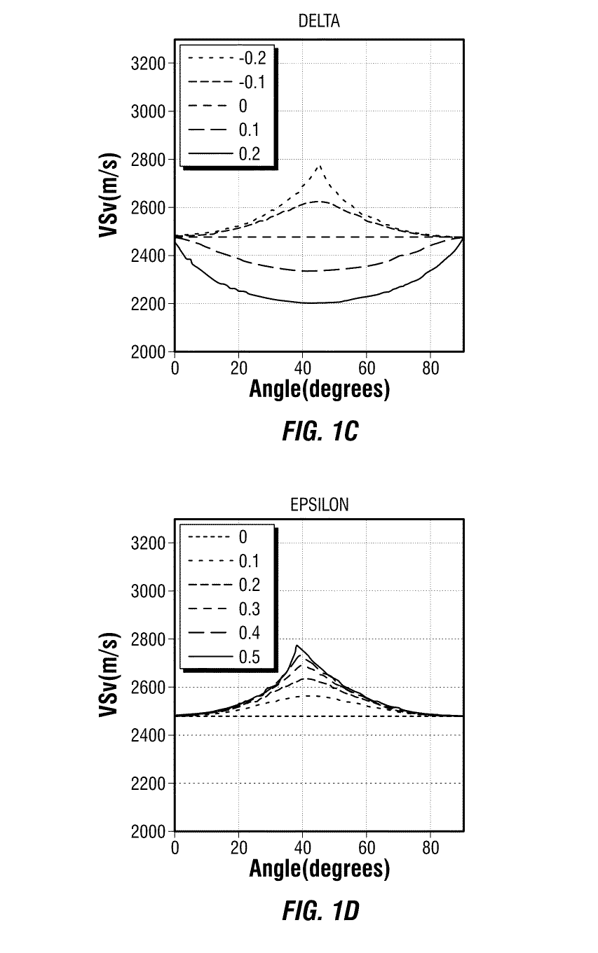

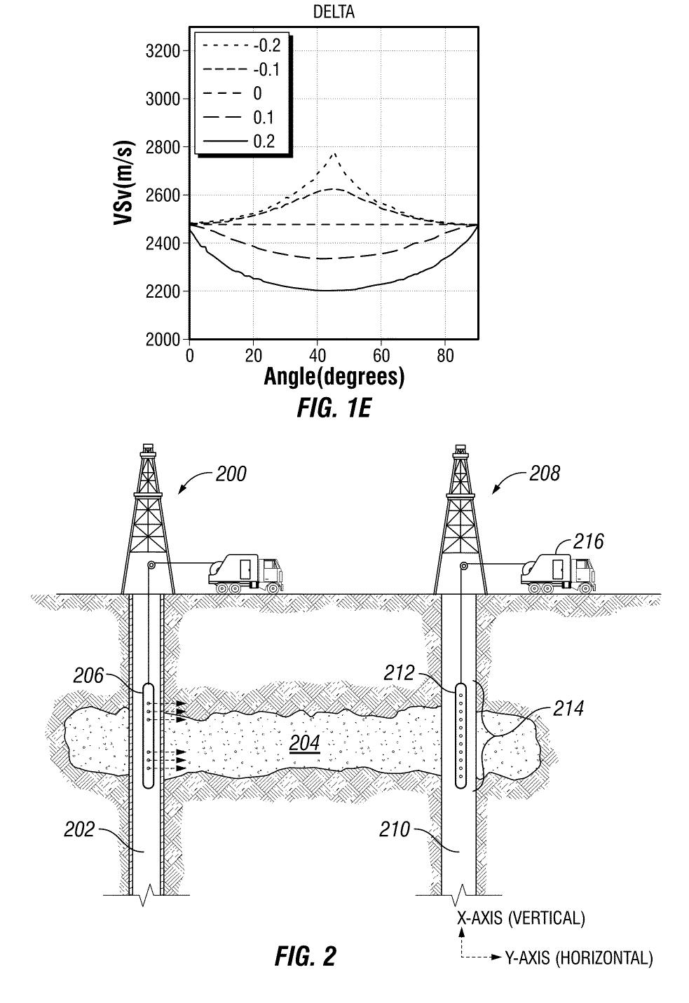

Thomsen parameters impact velocities of seismic waves traveling through geological formations. The Thomsen parameters can be determined by analyzing the velocities the seismic waves. FIGS. 1A-1E show sensitivities of group velocities of seismic waves, as functions of phase angles measured from a vertical symmetry axis, when varying one Thomsen parameter and keeping the two other parameters equal to zero. Each Thomsen parameter is varied by values from −0.2 to 0.2 or 0 to 0.5. FIG. 1A shows that velocities for Sh-waves are influenced by Thomsen parameter gamma. Sh-waves are shear waves that are polarized so that their direction of propagation is in a horizontal plane. FIGS. 1B and 1D shows that both P-wave and Sv-wave velocities are influenced by Thomsen parameter epsilon. Sv-waves are shear waves that are polarized so that their direction of propagation is in a vertical plane. FIG. 1C shows that Thomsen parameter delta significantly impacts Sv-wave velocities. FIG. 1E shows that Thomsen parameter delta also affects P-wave velocities, but to a much lesser extent than, for example, Thomsen parameter epsilon.

Thomson parameters epsilon and gamma can be determined from measurements made before a fracturing operation occurs, but Thomsen parameter delta can be more difficult to determine. As shown in FIGS. 1A and 1B, Thomsen parameter epsilon controls the propagation of P-waves in a horizontal direction (assuming a vertical axis of symmetry) and parameter gamma controls the propagation of Sh-waves in a horizontal direction. Both Thomsen parameters epsilon and gamma can be estimated from sonic logging measurements or from core measurements at 0 or 90 degrees to the symmetry axis. In particular, at microseismic frequency ranges, Thomsen parameters epsilon and gamma can be estimated from microseismic data produced by a perforation operation. Thomsen parameters epsilon and gamma can be determined by analyzing travel time of P-waves (for epsilon) and Sh-waves (for gamma) as functions of polarization angles at which the waves arrive at downhole monitoring receivers. The parameter delta mostly controls Sv-wave propagation in oblique directions, especially around 45 degrees to the symmetry axis of the formation. Due to Thomsen parameter delta's poor sensitivity to waves propagating at 0 and 90 degrees, parameter delta can be difficult to determine from sonic logging measurements and, in many cases, from small core samples.

FIG. 2 shows two well sites and a system for determining an elastic property of a geological formation, such as Thomsen parameter delta. The first well site is a treatment well 200 with a cased wellbore 202 that traverses the geological formation 204. A wellbore tool 206 is suspended within the cased wellbore 202. The wireline tool may include a perforation device for performing a perforation operation, such as a perforator gun. A perforation operation uses an explosive charge that fires and creates holes within the casing of the wellbore. This explosive charge is also referred to as a “perforation shot.” The holes within the casing allow the formation 204 and an inner volume of the case wellbore 202 to communicate through the casing. For example, in some cases, the holes are used to inject fluid into the formation 204 during a hydraulic fracturing operation. The perforation operation creates seismic waves that travel through the formation 204.

The second well site is a monitoring well 208 with a wellbore 210 that traverses the geological formation 204. A second wireline tool 212 is suspended within the wellbore using a cable. The second wireline tool 212 includes an array of seismic receivers 216 arranged along a vertical axis of the tool (e.g., 2, 5, 11, or 20 seismic receivers). The array of seismic receivers 216 detects the seismic waves that are generated by the perforation shots and that travel through the formation 204 to the monitoring well 208. The data from these seismic measurements is communicated through the cable to surface equipment 216, which may include a processing system for storing and processing the seismic data. In this case, the surface equipment 216 includes a truck that supports the second wireline tool 212. In another embodiment, however, the surface equipment may be located within a cabin on an off-shore platform.

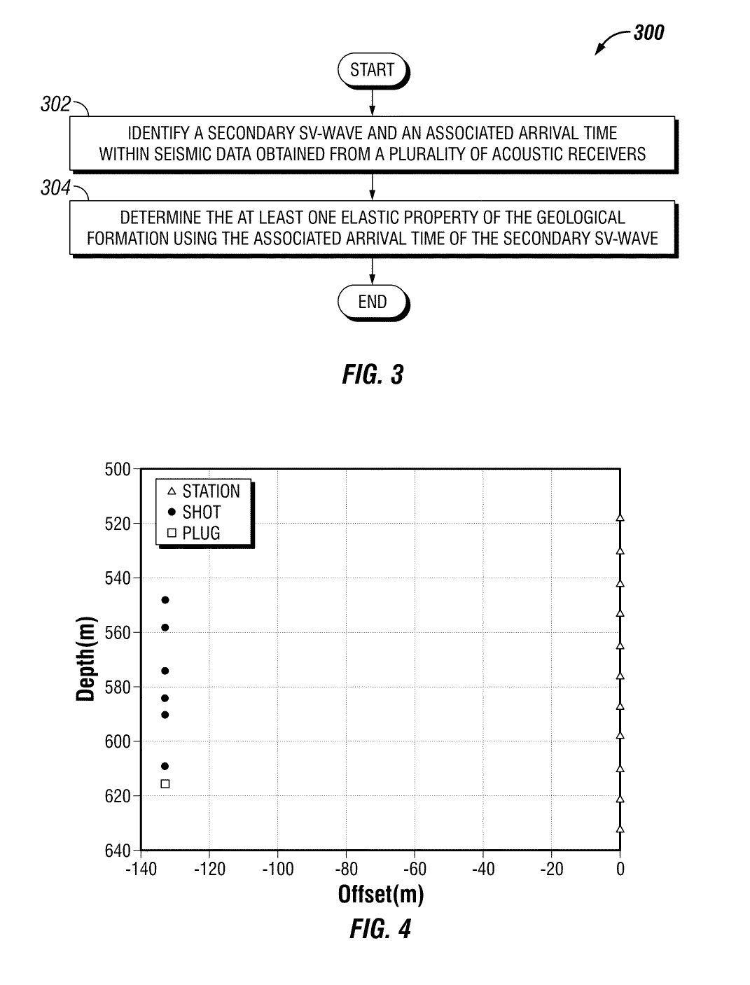

FIG. 3 shows a method 300 for determining one or more elastic properties of a geological formation. At process 302, a number of secondary Sv-waves and associated arrival times are identified within seismic data obtained from an array of seismic receivers. Sv-waves are shear waves that are polarized so that their direction of propagation is in a vertical plane. Sv-waves traveling in oblique directions (e.g., near 45 degrees) can be used to determine Thomsen parameter delta, as shown in FIG. 1C. Secondary Sv-waves are Sv-waves that are converted within a medium, such as a well or a formation, from other waves, such as P-waves, Sh-waves, or tube waves. Secondary Sv-waves are not generated directly by a primary source. For example, in FIG. 2, the perforation operation produces seismic waves that travel through the formation 204. The perforation operation is the primary source of seismic waves. As explained above, the perforation operation may not produce substantial Sv-waves, but P-waves and Sh-waves will travel from the treatment well 200 to the monitoring well 208. The perforation operation may also produce a tube wave that travels through the wellbore 202. In some cases, this tube wave may be converted into secondary Sv-waves by a feature within the wellbore 202 (e.g., a plug or deviation within the wellbore). This feature is referred to herein as a “secondary source.” The secondary Sv-waves generated by the secondary source can then travel through the formation 204 and to the monitoring well 208 where they are detected by the array of seismic receivers 214. This is merely one example of how secondary Sv-waves are generated. In another example, secondary Sv-waves are generated from P-waves interacting with features in the formation.

The seismic data can be obtained in a number of different ways. For example, in one embodiment, the seismic data is obtained during a perforation operation, as shown in FIG. 2. In other embodiments, the seismic data is obtained from string shots or any other source that produces seismic data. Also, the seismic data can be obtained using a number of different tools. As shown in FIG. 2, a wireline tool with an array of seismic receivers can be used to obtain the seismic data. In other embodiments, seismic receivers disposed at surface locations can be used to obtain the seismic data.

The secondary Sv-waves and their arrival times can be determined for each receiver by identifying representative peaks within the seismic data. In many cases, P-waves will arrive first at the array of seismic receivers. The P-waves will be followed by Sh-wave and then secondary Sv-waves. Accordingly, in many cases, a third set of peaks (as a function of time) within the seismic data is representative of the Sv-waves and their arrival times. In some embodiments, the seismic data may be passed through a low pass filter (e.g., 100 Hz) to more readily identify peaks within the seismic data. Also, in some embodiments, a polarization analysis can be used to identify the Sv-waves.

At process 304, one or more elastic properties of the geological formation (e.g., Thomsen parameter delta) are determined using an associated arrival time of the secondary Sv-wave. Process 304 may include performing an inversion to determine the one or more elastic properties of the geological formation. In one embodiment, the arrival times of the secondary Sv-waves are inverted to determine the one or more elastic properties. In another embodiment, both the arrival times of secondary Sv-waves and the arrival times for P-waves are inverted to determine the one or more elastic properties. The inversion may be performed using a Bayesian probability method, such as the one described below.

As explained above, Thomsen parameter delta can be determined using the inversion process. In some embodiments, the value for Thomsen parameter delta may be presented as a probability density function. The inversion process can also be used to determine associated parameters, such as the vertical velocity of P-waves (α), the vertical velocity of S-waves, (β), Thomsen parameter epsilon (8ε), and Thomsen parameter gamma (γ). Thomsen parameter delta can be presented as a joint probability density function with one of these other parameters (e.g., a joint probability density function between parameter delta and parameter epsilon).

Alternative notation for the properties of the geological formation may also be used to represent Thomsen parameter delta. For example, defined in a Cartesian reference frame, the elastic stiffness tensor C for a transversely isotropic medium is defined as:

$$C = ( \begin{matrix}{C}_{11} & {C}_{12} & {C}_{13} & 0 & 0 & 0 \\ {C}_{12} & {C}_{11} & {C}_{13} & 0 & 0 & 0 \\ {C}_{13} & {C}_{13} & {C}_{33} & 0 & 0 & 0 \\ 0 & 0 & 0 & {C}_{44} & 0 & 0 \\ 0 & 0 & 0 & 0 & {C}_{44} & 0 \\ 0 & 0 & 0 & 0 & 0 & {C}_{66}\end{matrix} ) ,$$

where the transverse isotropic symmetry axis is parallel to the x₃-axis of the Cartesian reference frame. In another example, Thomsen parameter delta can be represented as a set geomechanical parameters, such as Young's moduli and Poisson's ratios. The relationships amongst the geomechanical parameters, the elastic stiffnesses C, and the Thomsen parameters are shown in Table 1 below.

TABLE 1
Relation between Thomsen Parameters and Elastic Stiffnesses

| | |
|---|---|
| α = \sqrt{C}₃₃/ρ_{b} | Vertical P-wave velocity |
| β = \sqrt{C}₄₄/ρ_{b} | Vertical S-wave velocity |
| ε = (C₁₁ − C₃₃)/(2C₃₃) | P-wave anisotropy |
| γ = (C₆₆ + C₄₄)/(2C₄₄) | S-wave anisotropy |
| δ = [(C₁₃ + C₄₄)² − (C₃₃ − C₄₄)² ]/ | Small-offset NMO factor |
| [2C₃₃(C₃₃ − C₄₄)] | |

Relation between Geomechanical Parameters and Elastic stiffnesses

| | |
|---|---|
| Eᵥ = C₃₃ − 2C₁₃²/(C₁₁ + C₁₂) | Vertical Young's |
| | modulus |
| Eₕ = [(C₁₁ − C₁₂ )(C₁₁C₃₃ − 2C₁₃² + C₁₂C₃₃)]/ | Horizontal |
| (C₁₁C₃₃ − C₁₃²) | Young's modulus |
| μᵥ = C₄₄ | Vertical plane |
| | shear modulus |
| μₕ = C₆₆ | Horizontal plane |
| | shear modulus |
| νᵥ = C₁₃/(C₁₁ + C₁₂) | Vertical Poisson's ratio |

Further details regarding the inversion process 304 and various variables used in the invention process are described below. The term N_{S} is representative of a number of source firings (e.g., perforation shots) to be processed (possibly for a given stage). The term N_{R} is representative of a number of monitoring seismic receivers which collect three-component (3-C) seismic waveforms during each source firing. The vector \hat{T} represents available travel time measurements. For a given source (sᵢ) and a receiver (rⱼ) the measurement vector comprises:
\hat{T}_{P}(sᵢ, rⱼ) are the arrival times of direct P-waves;
\hat{T}_{Sh}(sᵢ, rⱼ) are the arrival times of direct SH-waves; and
\dot{T}_{Sv}(eₖ, sᵢ, rⱼ) are the arrival times of the k^{th} secondary-source Sv-wave phase observed at the receiver(rⱼ) and due to the source firing (sᵢ).

The variable eₖ represents the location of the k^{th} secondary source. Secondary sources can be considered to be passive sources because their locations are typically reflection, refraction, or conversion points.

A transversely isotropic formation can be characterized by mass density (ρ_{b}) and five elastic parameters. As explained above, the five elastic parameters include: (i) vertical velocity of P-waves, (ii) vertical velocity of S-waves, and (iii) Thomsen parameter epsilon, (iv) Thomsen parameter gamma, and (v) Thomsen parameter delta. The mass density and the P-wave and S-wave vertical velocities can be determined from sonic logging of a vertical pilot well. Thus, a velocity model V that represents the formation is restricted to three unknown parameters, parameterized by three vectors of anisotropic Thomsen parameters epsilon, gamma, and delta. The size (M) of these anisotropic vectors depends on the number of anisotropic cells that are considered. The size (M) is equal to the number of layers for a layered medium. For example, M is equal to 1 for a homogeneous formation.

A general solution to an inference problem of estimating velocity model V given measurements \hat{T} is a posterior probability distribution function that combines information from the a priori probability distribution ρ with the likelihood function L. Further details regarding this general solution are provided in Albert Tarantola, Inverse problem Theory, Elsevier Science (1987) and Hugues Djikpesse et al., Multiparameter Norm Waveform Fitting: Interpretation of Gulf of Mexico Seismograms, Geophysics 64, pp. 670-679 (1999).

For a given velocity model V, and assuming uncorrelated measurement uncertainties, the likelihood function measuring how well travel times predicted by V fit measured arrival times can be expressed according to:

L(\hat{T}|s,e,V,\dot{T})−L_{P}(\hat{T}_{P}|s,V,\dot{T})L_{Sh}(\hat{T}_{Sh}|s,V,\dot{T})L_{Sv}(\hat{T}_{Sv}|s,e,V,\dot{T}), (1)

where L_{P}, L_{Sh}, and L_{Sv} represent the individual likelihood functions associated with the direct P-wave measurement (\hat{T}_{P}), the direct Sh-wave measurement (\hat{T}_{Sh},), and the secondary-source Sv-wave measurement (\hat{T}_{Sv}).

The individual likelihood functions for direct P-wave measurements (\hat{T}_{P}) and direct Sh-wave measurements (\hat{T}_{Sh},) are as follows:

$$\begin{matrix}{L}_{P} ( {\hat{T}}_{𝒫} \vert s , V , \mathring{T} ) ∝ exp ( - \frac{1}{2} {\sum }_{i , j} {[ \frac{{\hat{T}}_{𝒫} ( {s}_{i} , {r}_{j} ) - \mathring{T} ( {s}_{i} ) - {T}_{P} ( {s}_{i} , {r}_{j} \vert V )}{{σ}_{P} ( {s}_{i} , {r}_{j} \vert V )} ]}^{2} ) & ( 2 ) \\ {L}_{Sh} ( {\hat{T}}_{Sh} \vert s , V , \mathring{T} ) ∝ exp ( - \frac{1}{2} {\sum }_{i , j} {[ \frac{{\hat{T}}_{Sh} ( {s}_{i} , {r}_{j} ) - \mathring{T} ( {s}_{i} ) - {T}_{Sh} ( {s}_{i} , {r}_{j} \vert V )}{{σ}_{Sh} ( {s}_{i} , {r}_{j} \vert V )} ]}^{2} ) , & ( 3 )\end{matrix}$$

where T_{P}(sᵢ, rⱼ|V) and T_{Sh}(sᵢ, rⱼ|V) are predicted P-wave and Sh-wave travel times. The standard deviations σ_{P}(sᵢ, rⱼ|V) and σ_{Sh}(sᵢ, rⱼ∥V) are associated with time residuals \hat{T}_{P}(sᵢ, rⱼ)−\dot{T}(sᵢ)−T_{P}(sᵢ, rⱼ V) and \hat{T}_{Sh}(sᵢ, rⱼ)−\dot{T}(sᵢ)−T_{Sh}(sᵢ, rⱼ|V), respectively. The time residuals account for measurement uncertainties and modeling errors. The individual likelihood functions in equations 2 and 3 above assume that the measurement noise and the uncertainties associated with predicting travel time measurements are Gaussian with zero means and standard deviations σ_{P} σ_{Sh} and σ_{Sv}. Also, the individual likelihood functions assume that no secondary Sv-wave arrival data is available. Also, in equations 2 and 3, an initiation time for the source firing (\dot{T}(sᵢ)) is subtracted from observed arrival times (sᵢ) so that the differences can be compared to the predicted travel times. The proportionality constant ensures the integration of the probability distribution to unity.

In various embodiments, the source firing initiation time can be measured in-situ using an electrical device or the source firing initiation time can be estimated from the P-wave or Sh-wave propagation at either 0 degrees or 90 degrees (e.g., provided that sonic log measurements are available for epsilon and gamma). When no measurement of the initiation time is available and no appropriate sonic log is available to estimate the initiation time, the initiation time can be estimated as the mean value of mismatches between observed and predicted times across the receiver array. For instance, for P-wave arrival time, the following relationship can be used:

$$\mathring{T} ( {s}_{i} ) \approx \frac{1}{{N}_{r}} {\sum }_{j = 1}^{{N}_{r}} {\hat{T}}_{P} ( {s}_{i} , {r}_{j} ) - {T}_{P} ( {s}_{i} , {r}_{j} \vert V ) . \qquad ( 4 )$$

The location of the secondary source can be used in the inversion process. As explained above, the secondary source is the feature within the well or formation that generated the secondary Sv-waves. In some embodiments, the location of the secondary source is known with respect to the array of receivers in the monitoring well. Nonetheless, the initiation times of the secondary Sv-waves (e.g., time that the conversion or reflection occurred) may be uncertain. This uncertainty in initiation time can be removed by using the relative arrival times with respect to a reference receiver (r₀). The reference receiver can be any one of the receivers in the receiver array. The associated data likelihood function is as follows:

$${L}_{Sv} ( {\hat{T}}_{Sv} \vert s , e , V ) ∝ exp ( - \frac{1}{2} {\sum }_{i , j , k} {[ \frac{\begin{matrix}{\hat{T}}_{Sv} ( {s}_{i} , {r}_{j} , {e}_{k} ) - {\hat{T}}_{Sv} ( {s}_{i} , {r}_{0} , {e}_{k} ) - \\ [ {T}_{Sv} ( {s}_{i} , {r}_{j} , {e}_{k} \vert V ) - {T}_{Sv} ( {s}_{i} , {r}_{0} , {e}_{k} \vert V ) ]\end{matrix}}{{σ}_{Sv} ( {s}_{i} , {r}_{j} , {r}_{0} , {e}_{k} \vert V )} ]}^{2} ) , \qquad ( 5 )$$

where T_{Sv}(sᵢ, rⱼ, cₖ V) is the travel time of the secondary Sv-waves (predicted for the velocity model V) to travel from the secondary source (eₖ) to the receiver (rⱼ). The term σ_{Sv}(sᵢ, rⱼ, r₀, eₖ|V) is the standard deviation associated with the following time residual:

\hat{T}_{Sv}(sᵢ,rⱼ,eₖ)−\hat{T}_{Sv}(sᵢ,r₀,eₖ)−[T_{Sv}(sᵢ,rⱼ,eₖ|V)−T_{Sv}(sᵢ,r₀,eₖ|V)].

The source locations (s) for direct P-wave and Sh-wave arrivals may be considered known for downhole active sources, such as perforation shots. The posterior probability is proportional to the product of the a priori distribution on the unknown parameters and the data likelihood function:

ρ(V,e|\hat{T},s,\dot{T})∝ρ(V,\dot{T},e)L(\hat{T}|s,e,V,\dot{T}). (6)

The probability distribution ρ(V, \dot{T}, e) describes prior information available for the velocity model (V), the source firing initiation times (\dot{T}), and the location of secondary sources (e={eₖ}, k=1, . . . , Nₑ,) independently of the measurements (\hat{T}). Also, the locations of the secondary-source Sv-wave arrivals can be considered independent of each other. Furthermore, the locations are also independent of the source firing initiation times (\dot{T}). The probability distribution ρ(V, \dot{T}, e) can thus be expressed as:

$$\begin{matrix}ρ ( V , \mathring{T} , e ) = δ ( \mathring{T} \dot{{T}^{≀}} ) ρ ( V , e ) ; & ( 7 ) \\ ρ ( V , e ) = {\prod }_{k = 1}^{{N}_{e}} ρ ( {e}_{k} ) ρ ( V ) . & ( 8 )\end{matrix}$$

In equation 7, the term δ(.) is the Dirac delta function and the vector {dot over (\acute{T} represents the known initiation times of the source firings. The prior distribution ρ(V) describes information available for the velocity model V independent of the measurements \hat{T}.

In some embodiments, the prior distribution ρ(eₖ) can be uniformly distributed over all possible secondary source locations. A uniform prior distribution for the velocity model can also be used, except for the inequality constraint between γ, ε, δ, α, β, and ρ_{b} that results from:

−C₁₃²+C₃₃(C₁₁−C₆₆)>0. (9)

C₁₁, C₃₃, C₄₄, C₆₆, and C₁₃ are the five stiffness constants that could also be used, along with mass density, to describe any formation with transverse isotropy elasticity. These stiffness constants are related to the Thomsen parameters according to the relationship shown in Table 1.

The posterior probability density function is obtained by inserting equations 1 and 8 into equation 6 and rewriting L_{Sv}=Πₖ₌₁^{N}^{ₑ}L_{Sv,k}, as:

$$p ( V , e \vert \hat{T} , s , \mathring{T} ) = ρ ( V ) {L}_{P} ( {\hat{T}}_{P} \vert s , V , \mathring{T} ) {L}_{Sh} ( {\hat{T}}_{Sh} \vert s , V , \mathring{T} ) {\prod }_{k = 1}^{{N}_{c}} ρ ( {e}_{k} ) {L}_{Sv , k} ( {\hat{T}}_{Sv , k} \vert s , {e}_{k} , V , \mathring{T} ) . \qquad ( 10 )$$

In some embodiments, the inversion process is performed with a partial or unknown location for the secondary source. In many cases, the location of where the secondary Sv-wave is generated is either unknown or only partially known. Often secondary Sv-waves are observed on seismograms, but the origin of the secondary Sv-wave is not clear. Sometimes, the location of the secondary-source is only partially known. This might be the case if the secondary Sv-wave is generated by a reflection from a boundary within the formation. The depth of that boundary can be determined from well log information and/or by analyzing which receiver depth corresponds to the shortest travel time. In such cases, the waves recorded in the monitoring well usually travel within the plane containing both the treatment well and the monitoring well. If the y-axis is the one orthogonal to the plane containing the two wells, then the y-coordinate of the reflection point eₖ is the same y-coordinate as for the downhole sources and downhole receivers. In other words, the uncertainties in the reflection point eₖ can be reduced from a three-dimensional space to the x-axis along the reflection interface. The probability of a velocity model V to explain the data, including the secondary Sv-waves with uncertain origin locations, is obtained by marginalization as:

$$p ( V \vert \hat{T} , s , \mathring{T} ) = ρ ( V ) {L}_{P} ( {\hat{T}}_{P} \vert s , V , \mathring{T} ) {L}_{Sh} ( {\hat{T}}_{Sh} \vert s , V , \mathring{T} ) {\prod }_{k = 1}^{{N}_{e}} \int ρ ( {e}_{k} ) {L}_{Sv , k} ( {\hat{T}}_{Sv , k} \vert s , {e}_{k} , V , \mathring{T} ) d {e}_{k} . \qquad ( 11 )$$

The secondary Sv-wave arrival times can be incorporated into an inversion process to reduce uncertainties in the anisotropic velocity parameters. The value of this contribution is given by Πₖ₌₁^{N}^{ₑ}∫ρ(eₖ) L_{Sv,k}. In some embodiments, a grid search method is used to determine solutions and probability distributions for the elastic property (e.g., parameter delta). Other methods can also be used. For example, deterministic approaches can be used to determine a most likely solution and stochastic methods can be used to sample the probability distribution functions. Further details regarding deterministic approaches can be found in Hugues Djikpesse et al., A Practical Sequential Lexicographic Approach for Derivative-Free Black-Box Constrained Optimization, Engineering Optimization Journal 43, pp. 721-739 (2011) and Hugues Djikpesse et al., Bayesian Survey Design To Optimize Resolution in Waveform Inversion, Geophysics 77, pp. R81-R93 (2012).

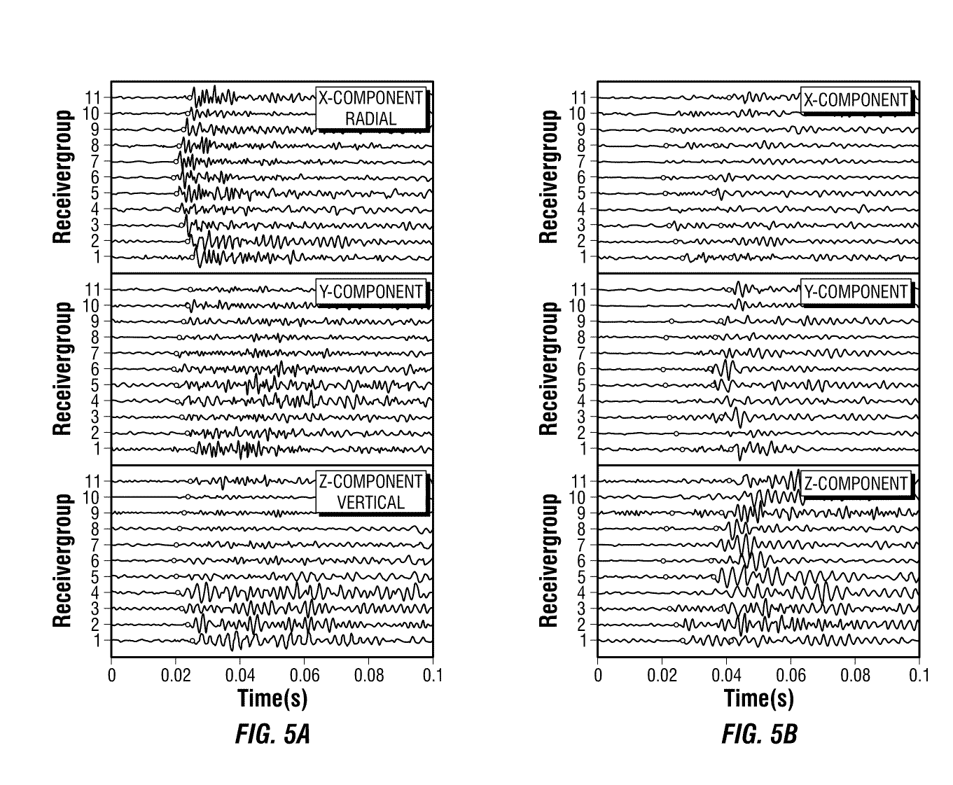

FIGS. 5A, 5B, 6A, 6B, 7, 8, 9, 10A, 10B, 11A, and 11B were generated using seismic data collected from a set of six perforation explosive sources detonated during one stage of a hydraulic fracturing operation. FIG. 4 shows a geographic arrangement for a vertical monitoring well and a vertical treatment well used to collect the seismic data. The vertical monitoring well includes an array of eleven receivers spaced apart by about 12 meters. The receivers are designated by triangles. Each receiver is a three-component receiver that records seismograms as seismic waves are induced by each of the perforation shots. The three components include a vertical component and two horizontal components. In some cases, the two horizontal components are transformed by rotation into radial and transverse components. The monitoring and treatment wells are separated by 138 meters. Each circle represents a perforation shot within the vertical treatment well performed at different depths. The square represents a plug.

FIGS. 5A and 5B show seismic data for one of the perforation shots (FIG. 5A) and a microseismic event (FIG. 5B) that occurred as a result of the perforation shot. Microseismic events can occur when rocks within the formation move, slide, or crack. FIG. 5A includes three-component gathers associated with the perforation shot after rotation to align one of the horizontal components with the source-receiver plane (referred to as the radial component). The other horizontal component is the transverse component. The vertical component remains unchanged. The black circles mark the arrival time of P-waves (first arrival) and Sv-waves (second arrival). While no direct Sv-waves are observed for the perforation data in FIG. 5A, Sv-waves are observed in FIG. 5B due to the microseismic event that occurs near the perforation shot. The seismic data presented in FIGS. 5A and 5B were band-pass filtered between 100 Hz and 1 kHz. Single traces were normalized using pre-arrival noise energy. Also, the traces within each receiver gather were normalized to unit amplitude.

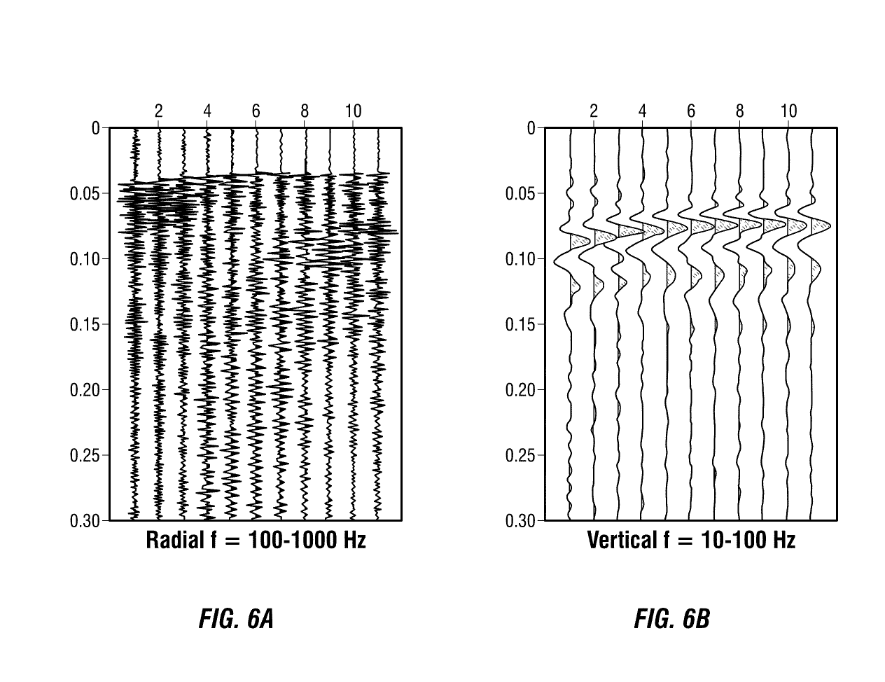

FIGS. 6A and 6B compare waveforms from the radial component in FIG. 5A to waveforms from the vertical component in FIG. 5A. The waveform from the radial component is filtered to remove frequencies below 100 Hz and the waveform from the vertical component is filtered to remove frequencies below 10 Hz and above 100 Hz. The low-frequency vertical data shows that, in addition to a direct P-wave arrival, there is a secondary Sv-wave arrival. This observation was made for each of the six data sets. The arrival times at each of the receivers can be used in an inversion process, as described above, to determine Thomsen parameter delta.

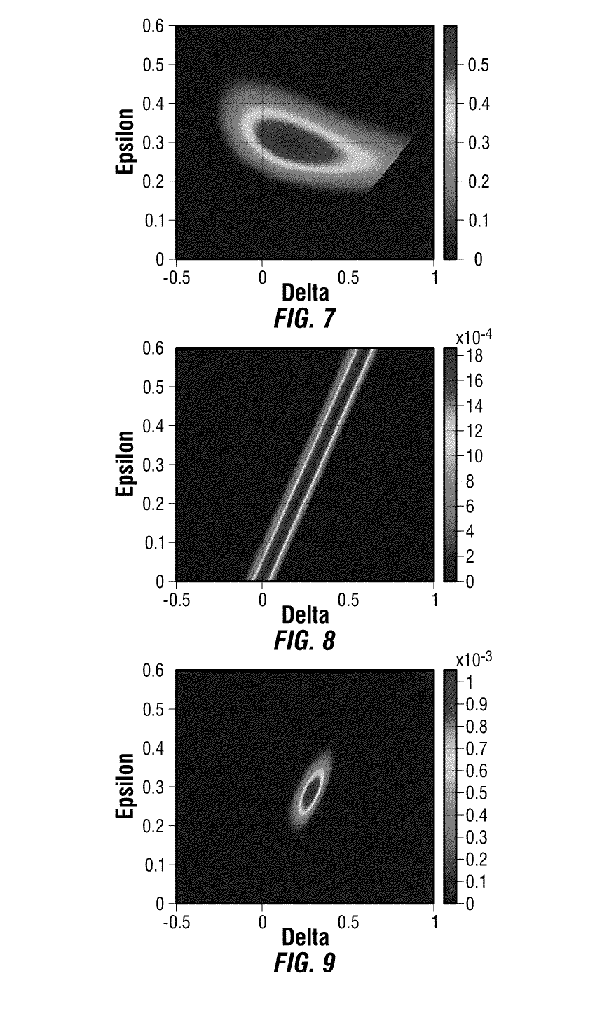

FIGS. 7, 8, 9, 10A, 10B, 11A, and 11B were generated using the inversion processes described above and the arrival times obtained from the set of six perforation explosive sources. FIG. 7 shows a two-dimensional marginal probability density for Thomsen parameters epsilon and delta. The Figure was generated by performing an inversion using direct P-wave arrival times alone. While parameter epsilon is fairly well resolved, parameter delta is poorly resolved. The impact of the constraint in equation 9, which is included in the prior probability distribution p(V), is shown in the lower-right corner of FIG. 7.

FIG. 8 shows a joint probability density for Thomsen parameters epsilon and delta. The Figure was generated by performing an inversion using secondary Sv-wave arrival times. A strong correlation between epsilon and delta is shown. This indicates that neither epsilon nor delta is well resolved by the Sv-wave arrival time alone.

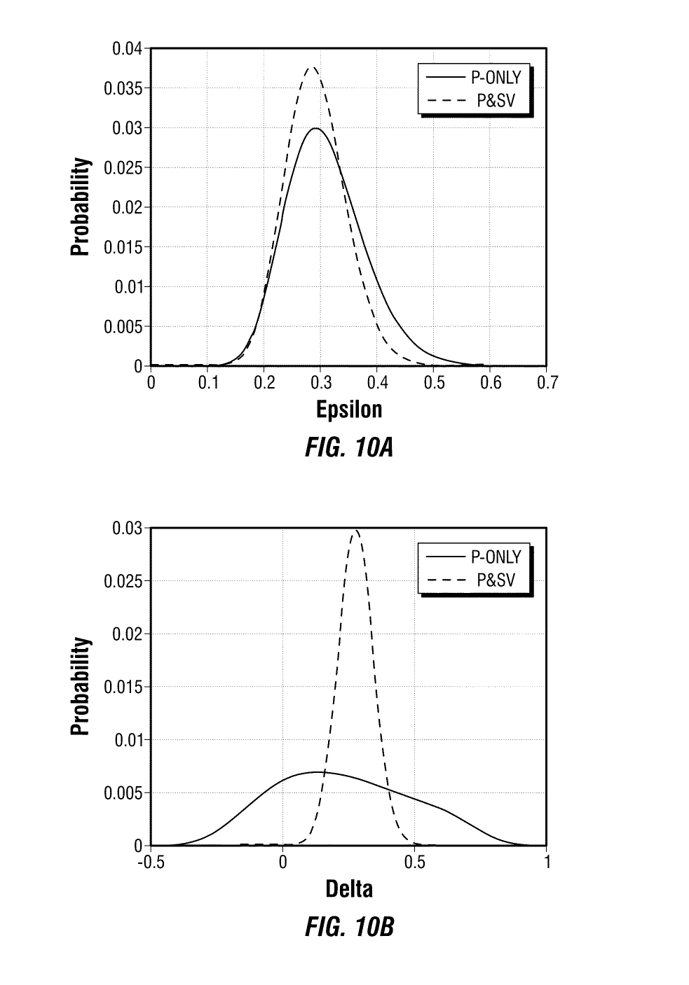

FIG. 9 shows a joint probability density for Thomsen parameters epsilon and delta. The Figure was generated by performing an inversion using both direct P-wave arrival times and secondary Sv-wave arrival times. By combining the direct P-wave times with the secondary Sv-wave arrival times, the uncertainty in the estimates of parameter epsilon and delta become much smaller. This reduction in uncertainty is further illustrated by FIGS. 10A and 10B, which show one-dimensional marginal probability distributions of parameters epsilon and delta, respectively. While the variance of the posterior distribution for parameter epsilon is slightly reduced by a factor 1.6, the variance of the posterior distribution for parameter delta is reduced by a factor 15, when the inversion uses the secondary Sv-wave arrival times.

FIGS. 8, 9, and 10B and their underlying values were generated using the inversion processes described above with a known secondary source location. Sv-wave arrival times and their move-out curves across the receiver array and across the different perforation shots can be used to estimate the location of the secondary-source. Further details regarding determining the location of secondary sources based on seismic data are provided in Tim Seher et al., Tube Wave to Shear Wave Conversion at Borehole Plugs, Geophysical Prospecting (2014) The Seher et al. reference describes using Sv-wave arrival times to identify a tube-to-body-wave conversion inside a treatment well.

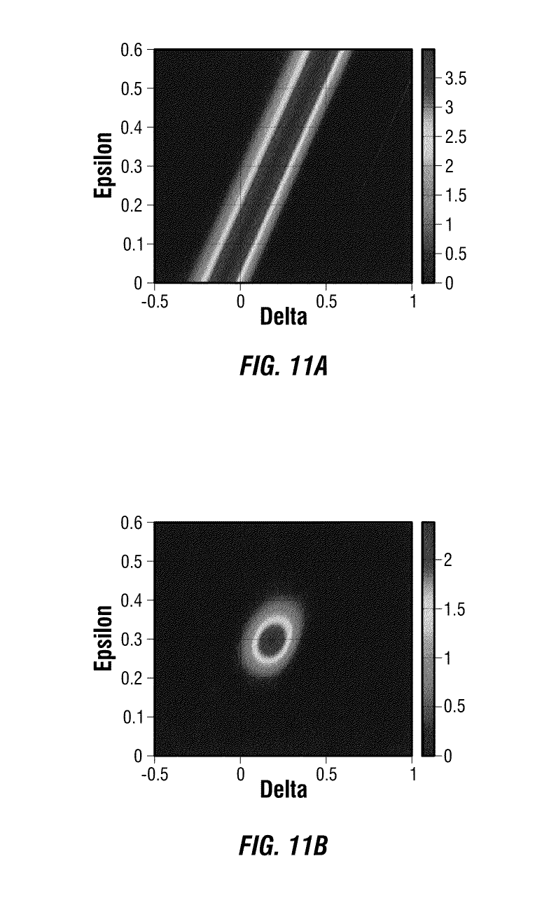

In other embodiments, the inversion process is performed with a partial or unknown location for the secondary source. FIGS. 11A and 11B show joint probability density functions for Thomsen parameters epsilon and delta. The Figures and their underlying values were generated using the inversion processes described above with an unknown secondary source location. FIG. 11A was generated by performing an inversion using secondary Sv-wave arrival times alone, while FIG. 11B was generated by performing an inversion using both direct P-wave arrival times and secondary Sv-wave arrival times. Equation 11 described above was used to marginalize the depth-dependent probability distributions over all equally-probable depth locations ranging from 609 m (the depth of the deepest perforation shot) to 632 m (the depth of the deepest monitoring receiver) with a depth increment of approximately 3 meters. In comparison to FIGS. 8 and 9, the posterior uncertainties (in FIGS. 11A and 11B) are larger when the secondary source location is unknown. A comparison of FIGS. 7 and 11B shows that secondary Sv-waves can reduce uncertainties in the Thomsen parameter delta even when the secondary source location of the Sv-waves cannot be determined.

The methods and systems described herein are not limited to any particular type of system arrangement. For example, the array of acoustic receivers described herein can be deployed within a wellbore as part of a wellbore tool (e.g., a wireline tool). The array of seismic receivers can be deployed in a single monitoring well or in a number of different monitoring wells. Furthermore, the array of seismic receiver can be deployed at surface locations.

The methods and systems described herein are not limited to analyzing any particular type of anisotropic formation. For example, the methods can be used to characterize transversely isotropic formations, such as shale formations, by using a single monitoring well. The methods can also be used to characterize orthorhombic formations by analyzing seismic data from a plurality of different monitoring wells.

The methods and systems described herein are not limited to any particular type of application. For example, the methods can be used to plan hydraulic fracturing operations. Seismic data generated from perforation operations is readily available before a hydraulic fracturing operation because perforation shots are used to break the casing prior to injection of fluid into the formation. Among other hydraulic fracturing applications, the methods described herein can be used to:
characterize geological formations and complement information available from available sonic data and surface seismic data;
reduce uncertainties in anisotropic velocity models for hydrofracture control;
reduce uncertainties in localization of microseismic events generated once the injection of high pressure fluid starts to fracture a low permeability reservoir;
predict fracture geometry, orientation, and gas deliverability in unconventional reservoirs; and
predict horizontal stress variation for field development planning for multi-stage fracturing.

Illustrative embodiments of the present disclosure use seismic waves and data generated by either passive or active sources to characterize geological formations. Seismic waves have frequencies in a range between 3 Hz to 1000 Hz. The method described herein can also use a subset of seismic waves and data to characterize geological formations. For example, the method can use microseismic waves and data to characterize geological formations. Microseismic waves are seismic waves that are generated by small passive seismic events or small active sources, such as perforation shots.

The processes described herein, such as (i) receiving seismic data from a number of seismic receivers located within a well, (ii) identifying secondary Sv-waves and associated arrival times within seismic data, (iii) identifying P-waves and associated arrival times within seismic data, (iv) determining an elastic property of a geological formation using associated arrival times of secondary Sv-waves, (v) performing an inversion using arrival times of secondary Sv-waves, and/or (vi) performing an inversion using arrival times of both secondary Sv-waves and P-waves, can be performed by a processing system.

Processes (i)-(vi), as listed above, can be performed at a variety of different locations. For example, in one embodiment, a processing system is located at the well site as part of the surface equipment (e.g., the truck 216 in FIG. 2). Processes (i)-(vi) are performed entirely at the well site using the processing system within the truck. The processing system acquires formation data from the wireline tool and uses the formation data to perform processes (i)-(vi). In some cases, these calculations may be performed in real-time at the well site. In another embodiment, processes (i)-(vi) are performed entirely at a location that is remote from the well site. For example, the processing system within the truck acquires the formation data and transmits the formation data over a communications network (e.g., a computer network) to a second processing system located at a remote location, such as an office building or a laboratory. The second processing system then performs processes (i)-(vi) using the formation data. In yet another embodiment, the processes (i)-(vi) are split between two different processing systems. For example, processes (i)-(ii) are performed at the well site by the processing system within the truck and then the results are communicated to the second processing system at the remote location. The second processing system then performs processes (iv)-(vi) using the results of processes (i)-(iii).

The term “processing system” should not be construed to limit the embodiments disclosed herein to any particular device type or system. The processing system may be a computer, such as a laptop computer, a desktop computer, or a mainframe computer. The processing system may include a graphical user interface (GUI) so that a user can interact with the processing system. The processing system may also include a processor (e.g., a microprocessor, microcontroller, digital signal processor, or general purpose computer) for executing any of the methods and processes described above (e.g. processes (i)-(vi)).

The processing system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. This memory may be used to store, for example, formation data, petrophysical log data, sonic log data, sonic velocity data, relative dip data, elastic property data, and/or uncertainty parameter data.

Any of the methods and processes described above, including processes (i)-(vii), as listed above, can be implemented as computer program logic for use with the processing system. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the processing system. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processing system may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Although several example embodiments have been described in detail above, those skilled in the art will readily appreciate that many modifications are possible in the example embodiments without materially departing from the scope of this disclosure. Accordingly, all such modifications are intended to be included within the scope of this disclosure.

What is claimed is:

1. A method for determining at least one elastic property of a geological formation, the method comprising:
identifying a secondary Sv-wave and an associated arrival time within seismic data obtained from a plurality of seismic receivers; and
determining the at least one elastic property of the geological formation using the associated arrival time of the secondary Sv-wave.

2. The method of claim 1, wherein the seismic data is representative of a perforation shot.

3. The method of claim 2, further comprising:
performing a perforation operation in a first well; and
receiving seismic data generated by the perforation operation at the plurality of seismic receivers located within a second well.

4. The method of claim 3, wherein the perforation operation produces a wave that is converted to a secondary Sv-wave that travels through the geological formation to the plurality of receivers located in the second well.

5. The method of claim 1, wherein the at least one elastic property comprises Thompsen parameter delta (δ).

6. The method of claim 1, wherein the at least one elastic property comprises three Thomsen parameters and two vertical-velocities.

7. The method of claim 1, wherein the at least one elastic property comprises components of an elastic stiffness tensor.

8. The method of claim 1, wherein the at least one elastic property comprises Young's moduli and Poisson's ratios.

9. The method of claim 1, wherein the formation is transversely isotropic.

10. The method of claim 1, wherein determining the at least one elastic property of the geological formation comprises performing an inversion using the arrival time of the secondary Sv-wave at each of the seismic receivers.

11. The method of claim 1, further comprising:
identifying a P-wave and an associated arrival time within seismic data obtained from the plurality of seismic receivers.

12. The method of claim 11, wherein determining the at least one elastic property of the geological formation comprises performing an inversion using the arrival times of both the secondary Sv-wave and the P-wave at each receiver.

13. The method of claim 10, wherein the inversion is performed using a Bayesian probability method.

14. The method of claim 10, wherein the at least one elastic property comprises a joint probability density function for Thompsen parameters epsilon (ε) and delta (δ).

15. The method of claim 10, wherein the inversion is performed using a known secondary source location.

16. The method of claim 10, wherein the inversion is performed using a partially known secondary source location.

17. The method of claim 10, wherein the inversion is performed without a secondary source location.

18. The method of claim 1, wherein the seismic data is microseismic data.

19. A system for determining at least one elastic property of a geological formation, the system comprising:
a processing system configured to (i) identify a secondary Sv-wave and an associated arrival time within seismic data obtained from a plurality of seismic receivers and (ii) determine the at least one elastic property of the geological formation using the associated arrival time of the secondary Sv-wave.

20. The system of claim 19, further comprising:
a plurality of seismic receivers deployed within a first wellbore and configured to receive seismic waves.

21. The system of claim 20, further comprising:
a seismic source deployed within a second wellbore and configured to generate seismic waves that travel to the first wellbore.

22. The system of claim 21, wherein the second wellbore is a cased wellbore and the seismic source is a perforation device.

23. The system of claim 19, wherein the at least one elastic property comprises Thompsen parameter delta (δ).

24. A non-transitory computer readable medium encoded with instructions, which, when loaded on a computer, establish processes for determining at least one elastic property of a geological formation, the processes comprising:
identifying a secondary Sv-wave and an associated arrival time within seismic data obtained from a plurality of seismic receivers; and
determining the at least one elastic property of the geological formation using the associated arrival time of the secondary Sv-wave.

25. The non-transitory computer readable medium of claim 24, wherein the at least one elastic property comprises Thompsen parameter delta (δ).
